(19) United States
(12) Patent Application Publication
(10) Pub. No.: US 2018/0240109 A1
(43) Pub. Date: Aug. 23, 2018

(54) Data Processing Method and System, and Wearable Electronic Device

(71) Applicant: Huawei Technologies Co., Ltd., Shenzhen, Guangdong (CN)

(72) Inventor: Zi Wang, Beijing (CN)

(21) Appl. No.: 15/751,785

(22) PCT Filed: Aug. 9, 2016
(86) PCT No.: PCT/CN2016/094157

§ 371 Date: Feb. 9, 2018

(30) Foreign Application Priority Data
Aug. 14, 2015 (CN) 201510502465.1

(51) Int. Cl. G06Q 20/38; G06Q 20/40

(52) U.S. Cl. CPC G06Q 20/3825; G06Q 20/40145

(57) ABSTRACT

A wearable electronic device, and a data processing method and system, where the data processing method includes switching a first operating system to a second operating system according to a first operation instruction, receiving, using a first application supported by the second operating system, first information from an intelligent terminal, wherein the first information comprises transaction data for completing online payment, determining, according to a second operation instruction, that the first information is correct, performing encryption or signature processing on the first information using the second operating system to obtain second information, and sending the second information to the intelligent terminal using the first application.

### CROSS-REFERENCE TO RELATED APPLICATIONS

This application is a U.S. National Stage of International Patent Application No. PCT/CN2016/094157 filed on Aug. 9, 2016, which claims priority to Chinese Patent Application No. 201510502465.1 filed on Aug. 14, 2015, both of which are hereby incorporated by reference in their entireties.

### TECHNICAL FIELD

The present disclosure relates to the field of communications technologies, and in particular, to a data processing method and system, and a wearable electronic device.

### BACKGROUND

With development of intelligent terminals, online transaction using an intelligent terminal becomes popular. An existing technical solution for completing online payment is based on a user name/password or short message service (SMS) message mechanism. The user name/password or SMS message mechanism is easily attacked by a payment virus, and the payment virus may read a user SMS message. The “user SMS message” herein includes a verification code for a payment transaction of a user. The payment virus may further embed malicious code into a payment application in a re-packaging manner. Consequently, software can be downloaded and installed without permission of the user, and a malicious subpackage may also be installed to further steal a bank account and password of the user and steal funds in the account of the user. This greatly threatens payment security of a payment client on an intelligent terminal.

Therefore, a security problem of online payment performed by a user using an intelligent terminal needs to be urgently resolved.

### SUMMARY

Embodiments of the present disclosure provide a data processing method and system, and a wearable electronic device in order to resolve a security problem of online payment performed by a user using an intelligent terminal.

According to a first aspect, an embodiment of the present disclosure provides a wearable electronic device, where the wearable electronic device includes a processor, a memory, a communications unit, an input unit, and a data processing unit. The memory is configured to store software programs and modules of a first operating system and a second operating system. The processor is configured to switch the first operating system to the second operating system according to a first operation instruction that is entered by a user and received by the input unit. The communications unit is configured to receive, using a first application supported by the second operating system, first information sent by an intelligent terminal, where the first information includes transaction data for completing online payment. The processor is further configured to determine, according to a second operation instruction that is entered by the user and received by the input unit, that the first information received by the communications unit is correct. The data processing unit is configured to perform, using the second operating system, encryption or signature processing on the first information that is determined to be correct by the processor, to obtain second information. The communications unit is further configured to send, to the intelligent terminal using the first application, the second information obtained by the data processing unit.

With reference to the first aspect, in a first possible implementation of the first aspect, the input unit is further configured to receive the second operation instruction entered by the user, and the second operation instruction is used to indicate that the first information is correct.

With reference to the first aspect or the first possible implementation of the first aspect, in a second possible implementation of the first aspect, the communications unit is further configured to establish a communication connection to the intelligent terminal in a wireless access mode. The processor is further configured to determine, according to a service request instruction that is sent by the intelligent terminal and received by the communications unit to run the first application supported by the second operating system, and the communications unit is further configured to send, to the intelligent terminal, a response message indicating that the first application has already been run.

With reference to any one of the foregoing possible implementations, in a third possible implementation of the first aspect, the input unit is further configured to receive the first operation instruction entered by the user, and the first operation instruction is used to switch the first operating system to the second operating system.

With reference to any one of the foregoing possible implementations, in a fourth possible implementation of the first aspect, the first operation instruction and the second operation instruction are any one type of voice instructions, fingerprint instructions, or keyboard instructions.

According to a second aspect, an embodiment of the present disclosure provides a data processing method, where the method includes switching a first operating system to a second operating system according to a received first operation instruction that is entered by a user, receiving, using a first application supported by the second operating system, first information sent by an intelligent terminal, where the first information includes transaction data for completing online payment, determining, according to a received second operation instruction that is entered by the user, that the first information is correct, performing encryption or signature processing on the first information using the second operating system to obtain second information, and sending the second information to the intelligent terminal using the first application.

With reference to the second aspect, in a first possible implementation of the second aspect, before determining, according to a received second operation instruction that is entered by the user, that the first information is correct, the method further includes receiving the second operation instruction, where the second operation instruction is used to indicate that the first information is correct.

With reference to the second aspect or the first possible implementation of the second aspect, in a second possible implementation of the first aspect, before receiving, using a first application supported by the second operating system, first information sent by an intelligent terminal, the method further includes establishing a communication connection to the intelligent terminal in a wireless access mode, determining, according to a service request instruction sent by the intelligent terminal to run the first application supported by the second operating system, and sending, to the intelligent terminal, a response message indicating that the first application has already been run.

With reference to any one of the foregoing possible implementations, in a third possible implementation of the second aspect, before switching a first operating system to a second operating system according to a received first operation instruction that is entered by a user, the method further includes receiving the first operation instruction entered by the user, where the first operation instruction is used to switch the first operating system to the second operating system.

With reference to any one of the foregoing possible implementations, in a fourth possible implementation of the second aspect, the first operation instruction and the second operation instruction are any one type of voice instructions, fingerprint instructions, or keyboard instructions.

According to a third aspect, an embodiment of the present disclosure provides a data processing system, where the system includes an intelligent terminal and a wearable electronic device. The intelligent terminal is configured to send first information to the wearable electronic device, where the first information includes transaction data for completing online payment. The wearable electronic device is configured to switch the first operating system to the second operating system according to a received first operation instruction that is entered by a user, receive, using a first application supported by the second operating system, the first information sent by the intelligent terminal, perform encryption or signature processing on the first information to obtain second information when the first information is correct, and send the second information to the intelligent terminal.

With reference to the third aspect, in a first possible implementation of the third aspect, the intelligent terminal is further configured to establish a communication connection to the wearable electronic device in a wireless access mode, and send a service request instruction to the wearable electronic device, where the service request instruction is used to instruct the wearable electronic device to determine to run the first application supported by the second operating system, and the wearable electronic device is further configured to receive the service request instruction, determine, according to the service request instruction to run the first application supported by the second operating system, and send, to the intelligent terminal, a response message indicating that the first application has already been run.

With reference to the third aspect or the first possible implementation of the third aspect, in a second possible implementation of the third aspect, the wearable electronic device is further configured to receive a second operation instruction entered by the user, and determine, according to the second operation instruction, that the first information is correct, where the second operation instruction is used to indicate that the first information is correct.

With reference to any one of the foregoing possible implementations, in a third possible implementation of the third aspect, the first operation instruction and the second operation instruction are any one type of voice instructions, fingerprint instructions, or keyboard instructions.

Based on the foregoing technical solutions, according to the wearable electronic device, and the data processing method and system that are provided in the embodiments of the present disclosure, encryption or signature processing is performed, using a second operating system, on first information that is used to complete online payment and sent by an intelligent terminal to obtain second information, and the second information is fed back to the intelligent terminal such that the intelligent terminal obtains the second information to complete the online payment, thereby resolving a security problem of online payment performed by a user using an intelligent terminal.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show merely some embodiments of the present disclosure, and a person of ordinary skill in the art may still derive other drawings from these accompanying drawings without creative efforts.

FIG. 1 is a schematic block diagram of a wearable electronic device according to an embodiment of the present disclosure;

FIG. 2 is a flowchart of a data processing method according to an embodiment of the present disclosure;

FIG. 3 is a flowchart of a data processing method according to another embodiment of the present disclosure;

FIG. 4 is a flowchart of a data processing method according to still another embodiment of the present disclosure;

FIG. 5 is a flowchart of a data processing method according to still another embodiment of the present disclosure;

FIG. 6 is a schematic interaction diagram of a data processing method according to still another embodiment of the present disclosure; and

FIG. 7 is a schematic block diagram of a data processing system according to an embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are some rather than all of the embodiments of the present disclosure. All other embodiments obtained by a person of ordinary skill in the art based on the embodiments of the present disclosure without creative efforts shall fall within the protection scope of the present disclosure.

It should be understood that, in the embodiments of the present disclosure, an intelligent terminal may be a device such as a smartphone or a tablet computer. The embodiments of the present disclosure set no limitation thereto.

It should further be understood that, in the embodiments of the present disclosure, a wearable electronic device is an intelligently designed device that is worn by a user, for example, intelligently designed clothes or accessories. Further, in the embodiments of the present disclosure, the wearable electronic device may be a device such as a smart band, a smart watch, or smart glasses. The embodiments of the present disclosure set no limitation thereto.

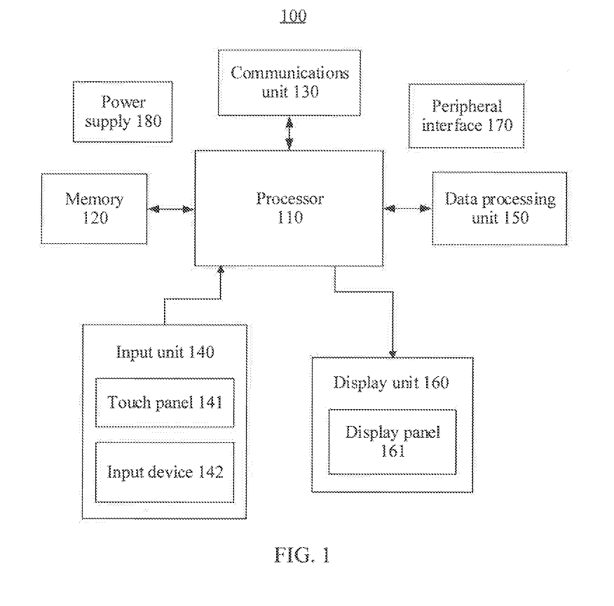

FIG. 1 is a schematic block diagram of a wearable electronic device 100 according to an embodiment of the present disclosure. The wearable electronic device 100 shown in FIG. 1 includes a processor 110, a memory 120, a communications unit 130, an input unit 140, and a data processing unit 150.

The memory 120 is configured to store software programs and modules of a first operating system and a second operating system.

The processor 110 is configured to switch the first operating system to the second operating system according to a first operation instruction that is entered by a user and received by the input unit 140.

The communications unit 130 is configured to receive, using a first application supported by the second operating system, first information sent by an intelligent terminal, where the first information includes transaction data for completing online payment.

The processor 110 is further configured to determine, according to a second operation instruction that is entered by the user and received by the input unit 140, that the first information received by the communications unit 130 is correct.

The data processing unit 150 is configured to perform, using the second operating system, encryption or signature processing on the first information that is determined to be correct by the processor 110 to obtain second information.

The communications unit 130 is further configured to send, to the intelligent terminal using the first application, the second information obtained by the data processing unit 150.

Further, in this embodiment of the present disclosure, the processor 110 of the wearable electronic device 100 switches, according to the first operation instruction that is entered by the user and received by the input unit 140, the frequently used first operating system such as an ANDROID operating system that is stored in the memory 120 to the second operating system that has a security feature and that is stored in the memory 120, and determines, according to the second operation instruction received by the input unit 140, that the first information that is sent by the intelligent terminal and received by the communications unit 130 using the first application supported by the second operating system is correct. The first information includes the transaction data for completing online payment. The data processing unit 150 performs, using the second operating system, encryption or signature processing on the first information that is determined to be correct by the processor 110 to obtain the second information. The communications unit 130 sends, to the intelligent terminal using the first application supported by the second operating system, the second information obtained by the data processing unit 150 such that the intelligent terminal obtains the second information to complete online payment.

Therefore, the wearable electronic device 100 provided in this embodiment of the present disclosure performs, using a second operating system, encryption or signature processing on first information that is used to complete online payment and sent by an intelligent terminal to obtain second information, and feeds back the second information to the intelligent terminal such that the intelligent terminal obtains the second information to complete the online payment, thereby resolving a security problem of online payment performed by a user using an intelligent terminal.

It should be understood that, in this embodiment of the present disclosure, the security feature of the second operating system is embodied as follows. Firstly, a startup process of the second operating system is secure, that is, step-by-step signature authentication is required during each time of startup to ensure that the system is not tampered, secondly, the second operating system has a strict software entry, and a software source of the second operating system is strictly controlled by means of software auditing and code signing to ensure that no malicious software enters, thirdly, the second operating system provides limited functions and occupies quite small memory space, and therefore, a vulnerability possibility is greatly reduced, fourthly, the second operating system does not run when the first operating system (for example, the frequently used ANDROID operating system) is running to ensure that the second operating system suffers no security attack from the first operating system, and fifthly, only this operating system provides an interface for accessing the data processing unit 150, for example, the second operating system may be a simple graphics system.

It should be noted that, in this embodiment of the present disclosure, the wearable electronic device 100 shown in FIG. 1 further includes components such as a display unit 160, a peripheral interface 170, and a power supply 180. The components shown in FIG. 1 may communicate with each other using one or more buses. A person skilled in the art may understand that a structure of the wearable electronic device 100 shown in FIG. 1 does not constitute a limitation on the present disclosure. The structure may be a bus structure, or may be a star structure. The wearable electronic device 100 may further include more or fewer components than those shown in FIG. 1, or combine some components, or have different component arrangements.

It should further be noted that the wearable electronic device 100 provided in this embodiment is merely an example, and the wearable electronic device 100 involved in this embodiment of the present disclosure may have more or fewer components than those shown in FIG. 1, may combine two or more components, or may have different component configurations or settings. Each component may be implemented in hardware, software, or a combination of hardware and software that includes one or more signal processing and/or application-specific integrated circuits.

The following describes all components that are included in the wearable electronic device 100 shown in FIG. 1.

The processor 110 is used as a control center of the wearable electronic device 100, may connect to the components of the entire wearable electronic device 100 using various interfaces and lines, and execute various functions of the wearable electronic device 100 and/or process data by running or executing a software program and/or a module stored in the memory 120 and by invoking data stored in the memory 120.

The processor 110 may include an integrated circuit (IC), for example, may include a single packaged IC, or may include multiple packaged ICs having a same function or different functions.

In this embodiment of the present disclosure, the processor 110 may include a central processing unit (CPU), or may include a combination of a graphics processing unit (GPU), a digital signal processor (DSP), and a control chip (for example, a baseband chip) or a field programmable gate array (FPGA) chip in the communications unit 130. In this embodiment of the present disclosure, the CPU may include a single computing core, or may include multiple computing cores. This embodiment of the present disclosure sets no limitation thereto.

The memory 120 may be configured to store a software program and a module, and the processor 110 executes various function applications of the wearable electronic device 100 and processes data by running the software program and the module that are stored in the memory 120. Further, in this embodiment of the present disclosure, the memory 120 may store two operating systems, a first operating system is a frequently used operating system (for example, the ANDROID operating system), and a second operating system is a simplified operating system (for example, a simplified graphics system). The two operating systems cannot be run at the same time, and need to be switched using a switch (an element in the input unit 140). When payment is required, the user needs to actively switch the first operating system to the second operating system.

The memory 120 mainly includes a program storage area and a data storage area. The program storage area may store an operating system and an application program required by at least one function, for example, a sound playing program or an image playing program. The data storage area may store data (for example, audio data or a phone book) and the like that are created according to use of the wearable electronic device 100.

In this embodiment of the present disclosure, the memory 120 may include a nonvolatile random access memory (RAM) (NVRAM), a phase change RAM (PRAM), and a magnetoresistive RAM (MRAM), or may include at least one magnetic disk storage device, an electrically erasable programmable read-only memory (ROM) (EEPROM), and a flash storage device, for example, a NOR flash memory or a NAND flash memory.

The communications unit 130 may be configured to establish a communication channel such that the wearable electronic device 100 connects to a remote server or an intelligent terminal (for example, a mobile phone or a tablet computer) using the communication channel, sends data to the remote server or the intelligent terminal, and receives data from the remote server or the intelligent terminal.

In this embodiment of the present disclosure, the communications unit 130 may include a module used for wireless communication such as a wireless local area network (WLAN) module, a BLUETOOTH module, a near field communication (NFC) module, or a baseband module, and a radio frequency (RF) circuit that corresponds to the communications unit and that is used for WLAN communication, BLUETOOTH communication, infrared communication, and/or cellular communications system communication.

The input unit 140 may be configured to implement interaction between the user and the wearable electronic device 100 and/or input of information entered by the user into the wearable electronic device 100. For example, the input unit 140 may receive digit or character information that is entered by the user to generate signal input related to user settings or function control.

Further, in this embodiment of the present disclosure, the input unit 140 may include a touch panel 141 and an input device 142. The touch panel 141 is also referred to as a touchscreen, may collect a touch operation (for example, an operation of the user on the touch panel 141 or near the touch panel 141 using any proper object or accessory such as a finger or a stylus) of the user on or near the touch panel 141, and drive a corresponding connecting apparatus according to a preset program.

Optionally, the touch panel 141 may include two parts a touch detection apparatus and a touch controller. The touch detection apparatus detects a touch position of the user, detects a signal brought by a touch operation, and transmits the signal to the touch controller. The touch controller receives touch information from the touch detection apparatus, converts the touch information into coordinates of a touch point, then sends the coordinates of the touch point to the processor 110, and may receive and execute a command sent by the processor 110. In addition, the touch panel 141 may be of multiple types such as a resistance type, a capacitance type, an infrared type, or a surface acoustic wave type.

In addition to the touch panel 141, the input unit 140 may further include the input device 142. Further, the input device 142 may include but is not limited to one or more of a physical keyboard, a function key (for example, a volume control key or an on/off key), a trackball, a mouse, a joystick, or the like.

The data processing unit 150 may implement sensitive data storage and secure computing. The data processing unit 150 has a built-in CPU, memory (static RAM (SRAM) or Flash), and chip operating system (COS), and may store a key or a digital certificate of the user. In addition, the data processing unit 150 has a built-in algorithm engine, including a public key algorithm engine, a symmetric algorithm engine, a hash algorithm engine, and a random number generator to implement data encryption or signature processing.

The public key algorithm engine is configured to implement public key encryption, and the public key encryption refers to using a private key that needs to be private to an unauthorized user and a public key that may be public to any user. The public key is associated with the private key, and both the two keys are unique for a communication session. Data encrypted using the public key may be decrypted only using the private key, and data signed using the private key may be authenticated only using the public key. Because data needs to be encrypted using a key and needs to be decrypted using another key, a public key encryption algorithm is also referred to as an asymmetric algorithm.

The symmetric algorithm engine is configured to implement symmetric encryption, and a symmetric encryption algorithm refers to using a single private key to encrypt and decrypt data. Because any one having the key may decrypt the data using the key, it is necessary to prevent the key from being obtained by an unauthorized agent. Because a same key is used for both encryption and decryption, the symmetric encryption algorithm is also referred to as a private key encryption algorithm.

The hash algorithm engine is configured to implement hash function encryption, and a hash function is sometimes also referred to as a message-digest function, a hash function, or a hash function. In a process of hash function encryption, a key is not necessarily used, but many crypto algorithms are involved. Input data may be output as a hash value with a relatively short fixed length. This process is unidirectional, and a reverse operation is difficult to complete. In addition, a probability of generating a same hash value for two different inputs is quite small.

The random number generator is configured to generate a random number, and may generate a random encryption key during an encryption operation such that the generated key hardly reappears. This is conducive to security of data transmission.

In this embodiment of the present disclosure, the data processing unit 150 may further support a security interface such as a 7816 interface or a serial peripheral interface (SPI), and may also support a chip-level security detection and protection mechanism.

Further, in this embodiment of the present disclosure, the data processing unit 150 may store unique key information to ensure that only information that is processed using a key stored in the data processing unit 150 may be accepted by a payment organization. The data processing unit 150 may store a corresponding certificate and key of the user in the payment organization, and the certificate of the user is also stored on a platform side of the payment organization such that it may be ensured, using a unique correspondence between the certificate and the key, that a transaction is completed by an entity (i.e., the wearable electronic device 100) having the key. That is, the data processing unit 150 may store a key (a certificate) related to payment, bank card information, and the like, and the key may totally be randomly generated in the data processing unit 150 and stored in the data processing unit 150 in order to ensure that the key is not exported from the data processing unit 150. Because the data processing unit 150 stores the corresponding certificate and a private key corresponding to the certificate that are of the user in the payment organization, and the private key cannot be exported, only data that is encrypted or signed using the private key may be authenticated on a server (the payment organization is on a platform side of the server) in order to ensure that the transaction may be completed only when the data processing unit 150 is used.

The wearable electronic device 100 further includes the display unit 160 that may be configured to display information entered by the user, information provided for the user, and various menus of the wearable electronic device 100. The display unit 160 may include a display panel 161, and optionally, the display panel 161 may be configured in a form of a liquid crystal display (LCD), an organic light-emitting diode (OLED), or the like.

Further, the touch panel 141 may cover the display panel 161. When detecting a touch operation on or near the touch panel 141, the touch panel 141 transmits the touch operation to the processor 110 to determine a type of a touch event, and then the processor 110 provides corresponding visual output on the display panel 161 according to the type of the touch event.

Although the touch panel 141 and the display panel 161 in FIG. 1 are used as two independent components to implement input and output functions of the wearable electronic device 100, in some embodiments, the touch panel 141 and the display panel 161 may be integrated to implement the input and output functions of the wearable electronic device 100.

The wearable electronic device 100 further includes the peripheral interface 170, which is an interface that may be configured to connect an external device and the wearable electronic device 100. The external device includes but is not limited to one or more of a keyboard, a mouse, a touchpad, a trackball, a joystick, a game controller, a microphone, a display, a sound box, a power amplifier, or the like. The external device connects to the processor 110 of the wearable electronic device 100 using the peripheral interface 170, and inputs data (for example, digit or character information) into the processor 100 for processing, or reads data from the processor 100 and outputs the data to the external device using the peripheral interface 170.

In this embodiment of the present disclosure, the peripheral interface 170 includes but is not limited to a universal serial bus (USB) interface, a mini-USB interface, a peripheral component interconnect (PCI) interface, the Institute of Electrical and Electronics Engineers (IEEE) 1394 interface, a video graphics array (VGA) interface, a high definition multimedia interface (HDMI), and the like, or is any one or combination of the foregoing interfaces.

The wearable electronic device 100 further includes the power supply 180 that is configured to supply power to the different components of the wearable electronic device 100 to maintain operation of the components. Generally, the power supply 180 may be a built-in battery such as a common lithium-ion battery or a nickel-metal hydride (NiMH) battery, or may include an external power supply that directly supplies power to the wearable electronic device 100, for example, an alternating current (AC) adapter.

In this embodiment of the present disclosure, the power supply 180 may further include a power management system, a charging system, a power failure detection circuit, a power converter or inverter, a power status indicator (for example, a light emitting diode), and any other components related to electric energy generation, management, and distribution of the wearable electronic device 100.

Optionally, in an embodiment of the present disclosure, the input unit 140 is further configured to receive the second operation instruction entered by the user, and the second operation instruction is used to indicate that the first information is correct.

Further, in this embodiment of the present disclosure, after the processor 110 of the wearable electronic device 100 switches the first operating system to the second operating system, and the communications unit 130 receives, using the first application supported by the second operating system, the first information sent by the intelligent terminal, the processor 110 determines, according to the second operation instruction that is used to indicate that the first information is correct and that is received by the input unit 140, that the first information is correct. The first information includes the transaction data for completing online payment. Further, the data processing unit 150 performs, using the second operating system, encryption or signature processing on the first information that is determined to be correct by the processor 110 to obtain the second information. That is, the first information received by the communications unit 130 may be presented on the wearable electronic device 100. This may ensure authenticity of the first information.

If the transaction data is tampered with by malicious software on the intelligent terminal, tampered data may be presented on the display unit 160 of the wearable electronic device 100. If the user finds that the transaction data is incorrect, the user may abandon a payment operation.

Optionally, in another embodiment of the present disclosure, the communications unit 130 may be further configured to establish a communication connection to the intelligent terminal in a wireless access mode, and the processor 110 may be further configured to determine, according to a service request instruction that is sent by the intelligent terminal and received by the communications unit 130 to run the first application supported by the second operating system, and the communications unit 130 sends, to the intelligent terminal, a response message indicating that the first application has already been run.

Further, in this embodiment of the present disclosure, after the processor 110 of the wearable electronic device 100 switches the first operating system to the second operating system, the communications unit 130 may establish the communication connection to the intelligent terminal in a wireless access mode. For example, after receiving a search message that is broadcast by the intelligent terminal according to a specified time period and a specified frequency, the wearable electronic device 100 sends a search response message to the intelligent terminal, and the search response message carries a BLUETOOTH address and clock information of the BLUETOOTH module of the wearable electronic device 100. When the intelligent terminal receives the search response message of the wearable electronic device 100, the user may tap on a screen of the intelligent terminal to establish a connection, and the intelligent terminal sends a BLUETOOTH address and a BLUETOOTH clock of the intelligent terminal to the wearable electronic device 100 such that the clock of the wearable electronic device 100 is synchronized with that of the intelligent terminal. A BLUETOOTH communications link between the intelligent terminal and the wearable electronic device 100 is established, and the intelligent terminal randomly generates a personal identification number (PIN), and sends the PIN to the wearable electronic device 100. After receiving the PIN, the wearable electronic device 100 determines whether PINs of the intelligent terminal and the wearable electronic device 100 are consistent to verify connection validity. When the user selects “accept” on the wearable electronic device 100, a BLUETOOTH connection is established between the intelligent terminal and the wearable electronic device 100, and data interaction may be performed between the intelligent terminal and the wearable electronic device 100 using BLUETOOTH.

After the intelligent terminal establishes the BLUETOOTH connection to the wearable electronic device 100, the intelligent terminal sends a service request command to the wearable electronic device 100 to obtain a corresponding service. The processor 110 of the wearable electronic device 100 determines, according to the service request instruction that is sent by the intelligent terminal and received by the communications unit 130 to run the first application supported by the second operating system, and the communications unit 130 sends, to the intelligent terminal, the response message indicating that the first application has already been run.

For example, the intelligent terminal sends a service request command to the wearable electronic device 100 to obtain a service of the Industrial and Commercial Bank of China, and according to the service request instruction that is sent by the intelligent terminal and received by the communications unit 130, the processor 110 of the wearable electronic device 100 determines and runs an application of the Industrial and Commercial Bank of China that is supported by the second operating system. The communications unit 130 sends, to the intelligent terminal, a response message indicating that the application of the Industrial and Commercial Bank of China has already been run.

It should be understood that, in this embodiment of the present disclosure, the intelligent terminal may further establish a WI-FI connection to the wearable electronic device 100. The second operating system may support multiple payment applications. Therefore, the wearable electronic device 100 may determine, from the multiple payment applications and according to the service request instruction sent by the intelligent terminal, an application corresponding to the instruction, and activate the application in order to receive the first information that includes the transaction data and that is sent by the intelligent terminal.

Optionally, in another embodiment of the present disclosure, the input unit 140 may be further configured to receive the first operation instruction entered by the user, and the first operation instruction is used to switch the first operating system to the second operating system. Further, in this embodiment of the present disclosure, before the processor 110 of the wearable electronic device 100 switches, according to the first operation instruction that is entered by the user and received by the input unit 140, the frequently used first operating system to the second operating system having the security feature, the input unit 140 may receive the first operation instruction that is used to instruct to switch the first operating system to the second operating system.

It should be understood that, in this embodiment of the present disclosure, the first operation instruction and the second operation instruction may be operation instructions entered in any one of the manners, voice input, fingerprint input, and keyboard input, that is, may be any one type of voice instructions, fingerprint instructions, or keyboard instructions.

It should further be understood that, in this embodiment of the present disclosure, the input unit 140 may be a touch panel, or may be another human-computer interaction interface such as a substantive input key or a microphone, or may be another external information collection apparatus such as a camera. This embodiment of the present disclosure sets no limitation thereto.

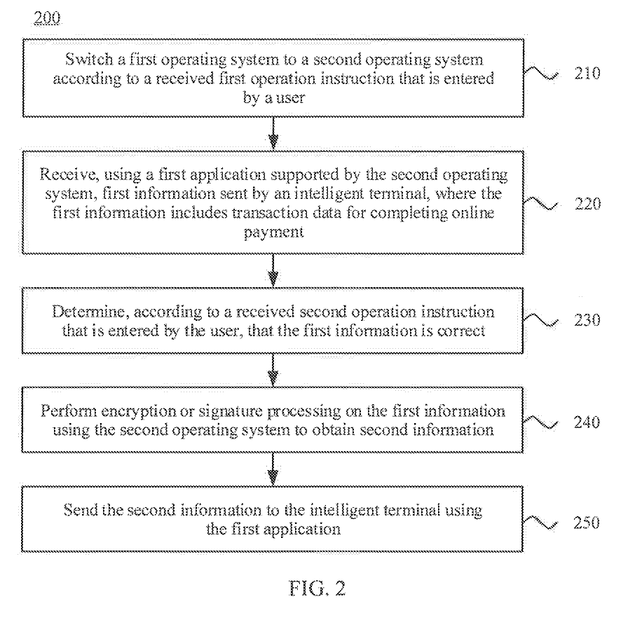

The wearable electronic device 100 according to the embodiment of the present disclosure is described above in detail with reference to FIG. 1, and data processing methods according to embodiments of the present disclosure are described below in detail with reference to FIG. 2 to FIG. 6.

FIG. 2 is a schematic flowchart of a data processing method 200 according to an embodiment of the present disclosure. The method 200 shown in FIG. 2 may be executed by a wearable electronic device, and the method 200 includes the following steps.

Step 210: Switch a first operating system to a second operating system according to a received first operation instruction that is entered by a user.

Step 220: Receive, using a first application supported by the second operating system, first information sent by an intelligent terminal, where the first information includes transaction data for completing online payment.

Step 230: Determine, according to a received second operation instruction that is entered by the user, that the first information is correct.

Step 240: Perform encryption or signature processing on the first information using the second operating system to obtain second information.

Step 250: Send the second information to the intelligent terminal using the first application.

Further, in this embodiment of the present disclosure, after the frequently used first operating system such as an ANDROID system is switched, according to the received first operation instruction that is entered by the user to the second operating system having a security feature, the first information sent by the intelligent terminal is received using the first application supported by the second operating system, and the first information includes the transaction data for completing online payment. It is determined, according to the received second operation instruction that is entered by the user, that the received first information is correct, and then encryption or signature processing is performed on the first information using the second operating system to obtain the second information. For example, the second operating system of the wearable electronic device may store unique key information, to ensure that only information that is processed using the key may be accepted by a payment organization. The second operating system of the wearable electronic device may store a corresponding certificate and key of the user in the payment organization, and the certificate of the user is also stored on a platform side of the payment organization such that it may be ensured, using a unique correspondence between the certificate and the key, that a transaction is completed by an entity (i.e., the wearable electronic device) having the key. Finally, the second information obtained by means of encryption or signature processing is sent to the intelligent terminal using the first application such that the intelligent terminal obtains the second information to complete online payment.

Therefore, according to the data processing method provided in this embodiment of the present disclosure, encryption or signature processing is performed, using a second operating system of a wearable electronic device, on first information that is used to complete online payment and sent by an intelligent terminal, to obtain second information, and the second information is fed back to the intelligent terminal such that the intelligent terminal obtains the second information to complete the online payment, thereby resolving a security problem of online payment performed by a user using an intelligent terminal.

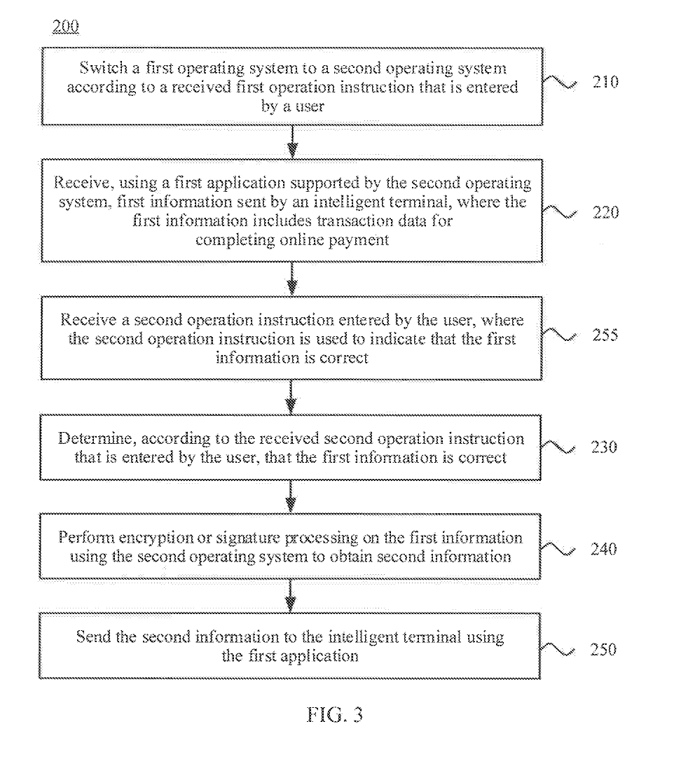

Optionally, in an embodiment of the present disclosure, as shown in FIG. 3, before step 230, the method 200 further includes the following step.

Step 255: Receive the second operation instruction entered by the user, where the second operation instruction is used to indicate that the first information is correct.

Further, in this embodiment of the present disclosure, after the first information sent by the intelligent terminal is received using the first application supported by the second operating system, the second operation instruction that is entered by the user and used to indicate that the first information is correct may be received, and the first information includes the transaction data for completing online payment. Then, it is determined, according to the received second operation instruction, that the first information is correct. Further, encryption or signature processing is performed on the first information using the second operating system to obtain the second information. That is, the received first information may be presented on the wearable electronic device. This may ensure authenticity of the first information. If the transaction data is tampered with by malicious software on the intelligent terminal, tampered data may be presented on a display of the wearable electronic device. If the user finds that the transaction data is incorrect, the user may abandon a payment operation.

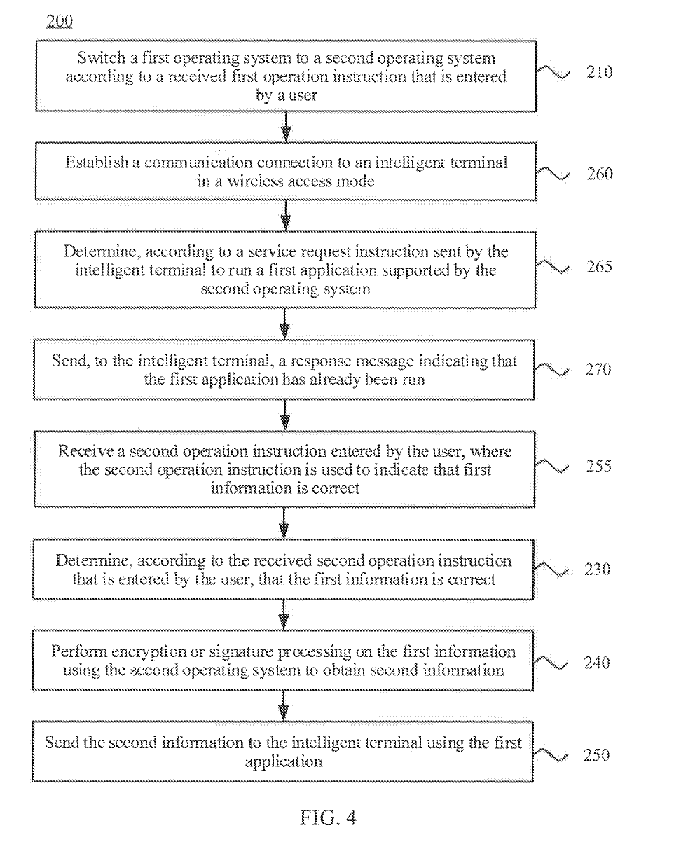

Optionally, in another embodiment of the present disclosure, as shown in FIG. 4, before step 255, the method 200 further includes the following steps.

Step 260: Establish a communication connection to the intelligent terminal in a wireless access mode.

Step 265: Determine, according to a service request instruction sent by the intelligent terminal to run the first application supported by the second operating system.

Step 270: Send, to the intelligent terminal, a response message indicating that the first application has already been run.

Further, in this embodiment of the present disclosure, after the frequently used first operating system is switched, according to the received first operation instruction that is entered by the user, to the second operating system having the security feature, the communication connection to the intelligent terminal may be established in a wireless access mode. After the intelligent terminal establishes a BLUETOOTH connection to the wearable electronic device, the intelligent terminal sends a service request command to the wearable electronic device to obtain a corresponding service. The wearable electronic device determines, according to the service request instruction sent by the intelligent terminal to run the first application supported by the second operating system, and sends, to the intelligent terminal, the response message indicating that the first application has already been run.

For example, the intelligent terminal sends a service request command to the wearable electronic device to obtain a service of the Industrial and Commercial Bank of China, and according to the service request instruction sent by the intelligent terminal, the wearable electronic device determines and runs an application of the Industrial and Commercial Bank of China that is supported by the second operating system, and sends, to the intelligent terminal, a response message indicating that the application of the Industrial and Commercial Bank of China has already been run.

It should be understood that, in this embodiment of the present disclosure, the intelligent terminal may further establish a WI-FI connection to the wearable electronic device. The second operating system may support multiple payment applications. Therefore, the wearable electronic device may determine, from the multiple payment applications and according to the service request instruction sent by the intelligent terminal, an application corresponding to the instruction, and activate the application in order to receive the first information that includes the transaction data and that is sent by the intelligent terminal.

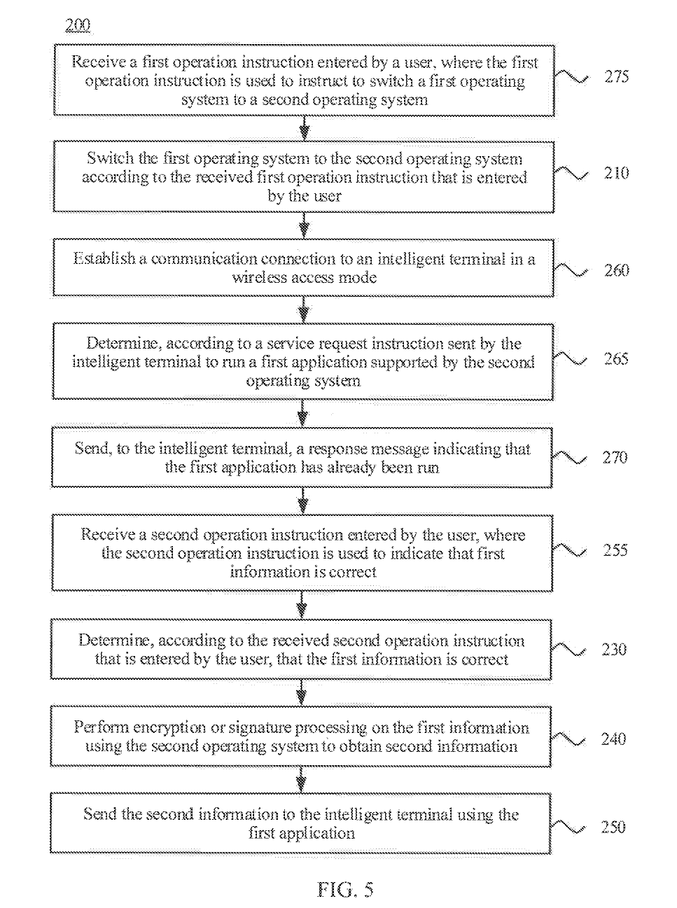

Optionally, in another embodiment of the present disclosure, as shown in FIG. 5, before step 210, the method 200 further includes the following step.

Step 275: Receive the first operation instruction entered by the user, where the first operation instruction is used to instruct to switch the first operating system to the second operating system.

Further, in this embodiment of the present disclosure, before the frequently used first operating system is switched, according to the received first operation instruction, to the second operating system having the security feature, the first operation instruction used to instruct to switch the first operating system to the second operating system may be received.

It should be understood that, in this embodiment of the present disclosure, the first operation instruction and the second operation instruction may be any one type of voice instructions, fingerprint instructions, or keyboard instructions.

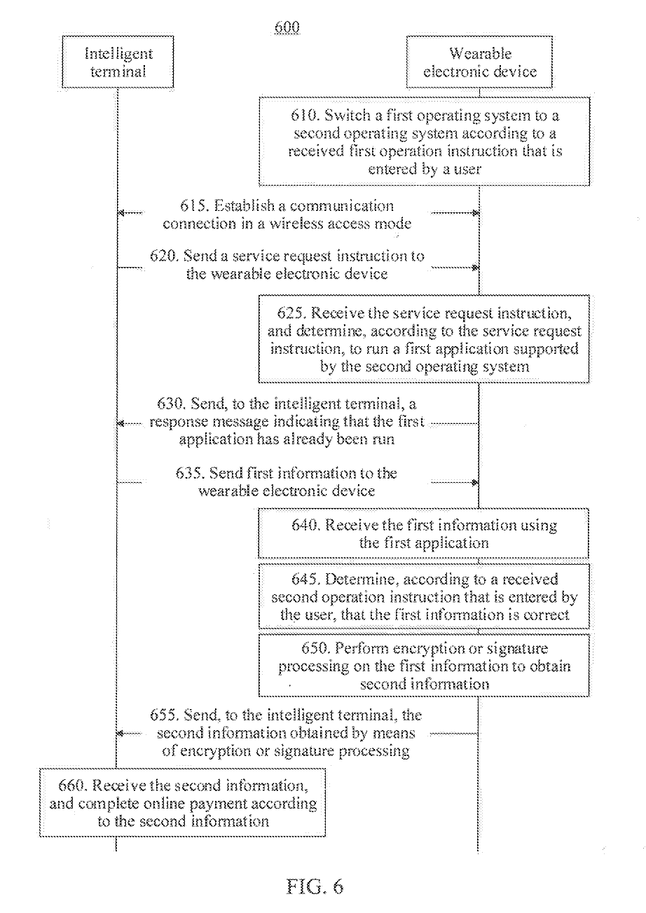

The technical solutions of the embodiments of the present disclosure are described below in detail with reference to a schematic interaction diagram, shown in FIG. 6, of a data processing method 600 according to an embodiment of the present disclosure. The method 600 shown in FIG. 6 includes the following steps.

Step 610: A wearable electronic device switches a first operating system to a second operating system according to a received first operation instruction that is entered by a user.

Further, in this embodiment of the present disclosure, when an online payment service needs to be performed, the user may enter the first operation instruction into the wearable electronic device, for example, enter an operation instruction into the wearable electronic device in a voice, keyboard, or fingerprint manner. The first operation instruction instructs the wearable electronic device to switch the frequently used first operating system such as an ANDROID operating system to the second operating system having a security feature.

Step 615: An intelligent terminal establishes a communication connection to the wearable electronic device in a wireless access mode.

Further, in this embodiment of the present disclosure, the intelligent terminal may establish the communication connection to the wearable electronic device in a BLUETOOTH or WI-FI manner.

Step 620: The intelligent terminal sends a service request instruction to the wearable electronic device, and the service request instruction is used to instruct the wearable electronic device to provide, for example, a related service of the Industrial and Commercial Bank of China.

Step 625: The wearable electronic device receives the service request instruction sent by the intelligent terminal, and according to the service request instruction, determines to run a first application supported by the second operating system, for example an application of the Industrial and Commercial Bank of China that is supported by the second operating system in order to provide a related service of the Industrial and Commercial Bank of China.

Step 630: The wearable electronic device sends, to the intelligent terminal, a response message indicating that the first application has already been run, for example the application of the Industrial and Commercial Bank of China has already been run, and the response message is used to indicate that the wearable electronic device may provide the related service of the Industrial and Commercial Bank of China.

Step 635: After receiving the response message, the intelligent terminal sends first information to the wearable electronic device, where the first information includes transaction data for completing online payment.

Step 640: The wearable electronic device receives, using a first application supported by the second operating system, the first information sent by the intelligent terminal.

Step 645: The wearable electronic device determines, according to a received second operation instruction that is entered by the user, that the first information is correct.

Further, in this embodiment of the present disclosure, the wearable electronic device receives, using the application of the Industrial and Commercial Bank of China, the first information sent by the intelligent terminal, the first information includes the transaction data for completing online payment, and the first information may be displayed on a display of the wearable electronic device. The user may enter the second operation instruction into the wearable electronic device, for example, may enter the second operation instruction in a voice, key, or fingerprint manner to determine that the first information is correct. If the user finds that the transaction data included in the first information is incorrect, the user may abandon a payment operation to avoid a loss.

Step 650: The wearable electronic device performs encryption or signature processing on the received first information using the second operating system to obtain second information.

Step 655: The wearable electronic device sends, to the intelligent terminal, the second information obtained by means of encryption or signature processing.

Step 660: The intelligent terminal receives the second information sent by the wearable electronic device, and completes online payment according to the second information.

Further, in this embodiment of the present disclosure, the wearable electronic device may perform encryption or signature processing on the received first information using the second operating system having the security feature to obtain the second information in order to ensure that only information that is processed using a key stored in the second operating system may be accepted by a payment organization. The wearable electronic device sends, to the intelligent terminal, the second information obtained by means of encryption or signature processing, and the intelligent terminal receives the second information and sends the second information to a platform of the payment organization. The payment organization receives the second information, completes a corresponding payment transaction after verifying that the second information is correct, and may send, to the intelligent terminal, a feedback message that carries information indicating that the transaction is completed.

Therefore, according to the data processing method provided in this embodiment of the present disclosure, encryption or signature processing is performed, using a second operating system of a wearable electronic device, on first information that is used to complete online payment and sent by an intelligent terminal to obtain second information, and the second information is fed back to the intelligent terminal such that the intelligent terminal obtains the second information to complete the online payment, thereby resolving a security problem of online payment performed by a user using an intelligent terminal.

It should be understood that, in the embodiments of the present disclosure, the method 200 according to the embodiments of the present disclosure may be correspondingly executed by the wearable electronic device 100 according to the embodiments of the present disclosure, and the corresponding procedures of the methods in FIG. 2 to FIG. 6 are separately implemented using the foregoing and other operations and/or functions of the modules of the wearable electronic device 100. For brevity, details are not described herein.

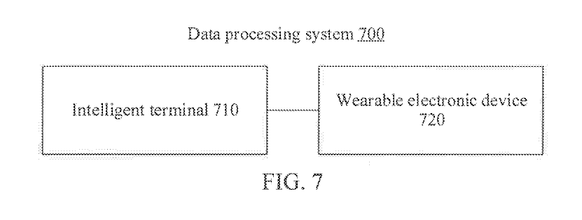

The data processing methods according to the embodiments of the present disclosure are described above in detail with reference to FIG. 2 to FIG. 6, and a data processing system according to an embodiment of the present disclosure is described below in detail with reference to FIG. 7.

FIG. 7 is a schematic diagram of a data processing system 700 according to an embodiment of the present disclosure. The data processing system 700 shown in FIG. 7 includes an intelligent terminal 710 and a wearable electronic device 720.

The intelligent terminal 710 is configured to send first information to the wearable electronic device 720, where the first information includes transaction data for completing online payment.

The wearable electronic device 720 is configured to switch the first operating system to the second operating system according to a received first operation instruction that is entered by a user, receive, using a first application supported by the second operating system, the first information sent by the intelligent terminal 710, perform encryption or signature processing on the first information to obtain second information when the first information is correct, and send the second information to the intelligent terminal 710.

Therefore, according to the data processing system 700 provided in this embodiment of the present disclosure, encryption or signature processing is performed, using a second operating system of the wearable electronic device 720, on first information that is used to complete online payment and sent by the intelligent terminal 710 to obtain second information, and the second information is fed back to the intelligent terminal 710 such that the intelligent terminal 710 obtains the second information to complete the online payment, thereby resolving a security problem of online payment performed by a user using an intelligent terminal.

It should be understood that, in this embodiment of the present disclosure, the wearable electronic device 720 may correspond to the wearable electronic device 100 according to the embodiment of the present disclosure. For brevity, details are not described herein.

Optionally, in an embodiment of the present disclosure, the intelligent terminal 710 may be further configured to establish a communication connection to the wearable electronic device 720 in a wireless access mode, and send a service request instruction to the wearable electronic device 720, where the service request instruction is used to instruct the wearable electronic device 720 to determine to run the first application supported by the second operating system, and the wearable electronic device 720 is further configured to receive the service request instruction sent by the intelligent terminal 710, determine, according to the service request instruction to run the first application supported by the second operating system, and send, to the intelligent terminal 710, a response message indicating that the first application has already been run.

Optionally, in another embodiment of the present disclosure, the wearable electronic device 720 is further configured to receive a second operation instruction entered by the user, and determine, according to the second operation instruction, that the first information is correct, where the second operation instruction is used to indicate that the first information is correct.

It should be understood that, in this embodiment of the present disclosure, the first operation instruction and the second operation instruction are any one type of voice instructions, fingerprint instructions, or keyboard instructions. This embodiment of the present disclosure sets no limitation thereto.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. A part or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to other approaches, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present disclosure. The foregoing storage medium includes any medium that can store program code, such as a USB flash drive, a removable hard disk, a ROM, a RAM, a magnetic disk, or an optical disc.

The foregoing descriptions are merely specific embodiments of the present disclosure, but are not intended to limit the protection scope of the present disclosure. Any modification or replacement readily figured out by a person skilled in the art within the technical scope disclosed in the present disclosure shall fall within the protection scope of the present disclosure. Therefore, the protection scope of the present disclosure shall be subject to the protection scope of the claims.

1-5. (canceled)

6. A data processing method, comprising:
switching a first operating system to a second operating system according to a first operation instruction;
receiving, using a first application supported by the second operating system, first information from an intelligent terminal, wherein the first information comprises transaction data for completing an online payment;
determining, according to a second operation instruction, that the first information is correct;
performing encryption or signature processing on the first information using the second operating system to obtain second information; and
sending the second information to the intelligent terminal using the first application.

7. The method according to claim 6, wherein before determining that the first information is correct, the method further comprises receiving the second operation instruction, and wherein the second operation instruction indicates that the first information is correct.

8. The method according to claim 6, wherein before receiving the first information from the intelligent terminal, the method further comprises:
establishing a communication connection to the intelligent terminal in a wireless access mode;
determining, according to a service request instruction from the intelligent terminal to run the first application supported by the second operating system; and
sending, to the intelligent terminal, a response message indicating that the first application has already been run.

9. The method according to claim 6, wherein before switching the first operating system to the second operating system, the method further comprises receiving the first operation instruction from the user, and wherein the first operation instruction instructs to switch the first operating system to the second operating system.

10. The method according to claim 6, wherein the first operation instruction and the second operation instruction are voice instructions.

11. A data processing system, comprising:
an intelligent terminal; and
a wearable electronic device coupled to the intelligent terminal,
wherein the intelligent terminal is configured to send first information to the wearable electronic device,
wherein the first information comprises transaction data for completing an online payment, and
wherein the wearable electronic device is configured to:
switch a first operating system to a second operating system according to a first operation instruction;
receive, using a first application supported by the second operating system, the first information from the intelligent terminal;
perform encryption or signature processing on the first information to obtain second information when the first information is correct; and
send the second information to the intelligent terminal.

12. The system according to claim 11, wherein the intelligent terminal is further configured to:
establish a communication connection to the wearable electronic device in a wireless access mode; and
send a service request instruction to the wearable electronic device, wherein the service request instruction instructs the wearable electronic device to determine to run the first application supported by the second operating system, and
wherein the wearable electronic device is further configured to:
receive the service request instruction;
determine, according to the service request instruction to run the first application supported by the second operating system; and
send, to the intelligent terminal, a response message indicating that the first application has already been run.

13. The system according to claim 11, wherein the wearable electronic device is further configured to:
receive a second operation instruction; and
determine, according to the second operation instruction, that the first information is correct, and
wherein the second operation instruction indicates that the first information is correct.

14. The system according to claim 11, wherein the first operation instruction and the second operation instruction are voice instructions.

15. A wearable electronic device, comprising:
a memory configured to store instructions; and
at least one processor coupled to the memory, wherein the instructions cause the at least one processor to be configured to:
switch a first operating system to a second operating system according to a first operation instruction;
receive, using a first application supported by the second operating system, first information from an intelligent terminal, wherein the first information comprises transaction data for completing an online payment;
determine, according to a second operation instruction, that the first information is correct;
perform encryption or signature processing on the first information using the second operating system to obtain second information; and
send the second information to the intelligent terminal using the first application.

16. The wearable electronic device according to claim 15, wherein the instructions further cause the at least one processor to be configured to receive the second operation instruction, and wherein the second operation instruction indicates that the first information is correct.

17. The wearable electronic device according to claim 15, wherein the instructions further cause the at least one processor to be configured to:
establish a communication connection to the intelligent terminal in a wireless access mode;
determine, according to a service request instruction from the intelligent terminal to run the first application supported by the second operating system; and
send, to the intelligent terminal, a response message indicating that the first application has already been run.

18. The wearable electronic device according to claim 15, wherein the instructions further cause the at least one processor to be configured to receive the first operation instruction, and wherein the first operation instruction instructs to switch the first operating system to the second operating system.

19. The wearable electronic device according to claim 15, wherein the first operation instruction and the second operation instruction are voice instructions.

20. The method according to claim 6, wherein the first operation instruction and the second operation instruction are fingerprint instructions.

21. The method according to claim 6, wherein the first operation instruction and the second operation instruction are keyboard instructions.

22. The system according to claim 11, wherein the first operation instruction and the second operation instruction are fingerprint instructions.

23. The system according to claim 11, wherein the first operation instruction and the second operation instruction are keyboard instructions.

24. The wearable electronic device according to claim 15, wherein the first operation instruction and the second operation instruction are fingerprint instructions.

25. The wearable electronic device according to claim 15, wherein the first operation instruction and the second operation instruction are keyboard instructions.
